(19) United States
(12) Patent Application Publication
(10) Pub. No.: US 2026/0319925 A1
(43) Pub. Date: Oct. 15, 2026

(54) SYSTEM AND METHOD FOR TEST STEP GENERATION

(71) Applicant: TOYOTA JIDOSHA KABUSHIKI KAISHA, Toyota-shi (JP)

(72) Inventor: Joshua SANTOSO, Ichikawa-shi (JP)

(73) Assignee: TOYOTA JIDOSHA KABUSHIKI KAISHA, Toyota-shi (JP)

(21) Appl. No.: 19/179,023

(22) Filed: Apr. 15, 2025

(51) Int. Cl. G06F 11/3668; G06F 11/3698

(52) U.S. Cl. CPC G06F 11/3684; G06F 11/3688; G06F 11/3698

(57) ABSTRACT

Provided are a method, system, and device for generating test steps. The method may include determining whether a user input to an integrated development environment (IDE) contains an error including an invalid test step; based on determining the user input contains an error, automatically generating a suggestion to correct the error; providing an appropriate template test step by using the invalid test step information inputted by the user; and generating a new test step based on the suggestion, the user input, and the appropriate template test step.

Example embodiments of the present disclosure relate to test step generation for software development.

### BACKGROUND

In the software development cycle, test steps are typically used by a developer in order to test the program based on code written. In the related art, a developer, for adding new test step(s) (for example, in a syntax such as Gherkin) in a software development kit (SDK) may use an integrated development environment (IDE) having a graphical user interface (GUI). Such an IDE may typically include autocompletion features and suggestions (autocomplete) in a text editor or console. For instance, based on the input of the user/developer, the IDE may suggest what the user intended to write based on an incomplete input.

The IDE's in related art do not integrate error handling with user suggestion with respect to generating new test steps. For example, if a test step containing invalid syntax is entered, it may not be properly detected. Further, the user may need to enter the new test step manually completely.

Accordingly, there is a need for an improved method for test step generation based on user input and integrating error handling with user suggestion.

### SUMMARY

Example embodiments consistent with the present disclosure provide a process for integrating error handling with user suggestion with respect to generating test steps in an IDE. In particular, apparatuses and methods according to example embodiments may include determining whether a user input to an integrated development environment (IDE) contains an error including an invalid test step; based on determining the user input contains an error, automatically generating a suggestion to correct the error; providing an appropriate template test step by using the invalid test step information inputted by the user; and generating a new test step based on the suggestion, the user input, and the appropriate template test step.

It can be understood that example embodiments of the present disclosure allow for integration of error handling with generating a new test step, such that the user/developer may be able to more seamlessly develop test steps and increase efficiency for testing in software development.

According to embodiments, the suggestion to correct the error may be previewed to a user in a user interface window. The suggestion to correct the error may include at least one input method to allow the user to select an option for fixing the error and adding the new test step. The at least one input method may include a button and a dropdown menu.

The method may include based on generating the new test step, prompting the user to edit the new test step. A title of the generated new test step may be based on the title of the test step from the user input. The error may further include at least one syntax error, and the suggestion further includes an explanation of the at least one syntax error and how to correct the at least one syntax error.

According to embodiments, an apparatus for generating a new test step may be provided, the apparatus including at least one memory storing computer-executable instructions; and at least one processor configured to execute the computer-executable instructions to determine whether a user input to an integrated development environment (IDE) contains an error including an invalid test step; based on determining the user input contains an error, automatically generate a suggestion to correct the error; provide an appropriate template test step by using the invalid test step information inputted by the user; and generate a new test step based on the suggestion, the user input, and the appropriate template test step.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates an example graphical user interface for detecting errors in an IDE according to one or more example embodiments;

FIG. 2 illustrates an example graphical user interface for handling errors in an IDE, according to one or more example embodiments;

FIG. 3 illustrates an example generated template test step, according to one or more example embodiments;

FIG. 4 illustrates an example method for implementing generating a test step, according to one or more example embodiments; and

FIG. 5 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide methods, systems, and devices for integrating error handling with user suggestion with respect to generating test steps in an IDE. In particular, apparatuses and methods according to example embodiments may include determining whether a user input to an integrated development environment (IDE) contains an error including an invalid test step; based on determining the user input contains an error, automatically generating a suggestion to correct the error; providing an appropriate template test step by using the invalid test step information inputted by the user; and generating a new test step based on the suggestion, the user input, and the appropriate template test step.

Based on the above, it can be understood that example embodiments of the present disclosure allow for integration of error handling with generating a new test step, such that the user/developer may be able to more seamlessly develop test steps and increase efficiency for testing in software development.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

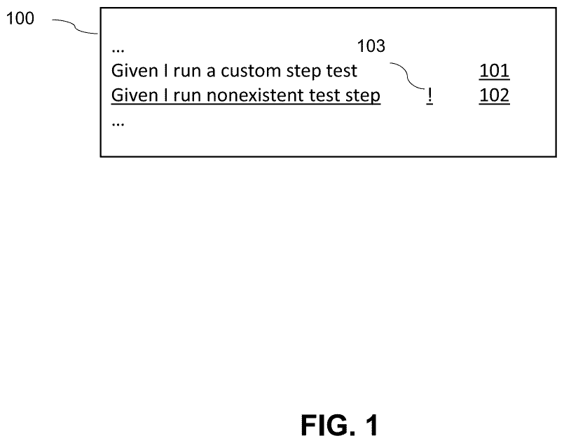

FIG. 1 illustrates an example graphical user interface 100 for detecting errors in an IDE according to one or more example embodiments. “Given I run a custom test step” line 101 may be an example of valid syntax. “Given I run nonexistent test step” line 102 may be an example of invalid syntax, as the test step may not exist or be defined. Accordingly, line 102 may be highlighted or underlined (e.g., in a color such as red) to indicate an error has occurred. Further, indicator icon 103 may appear next to the line 102 in order to further identify to the user that an error has occurred. Indicator 103 may be clickable and/or interactable by the user in order to see further details regarding the error. It may also be possible, for example, to hover over line 102 when it is underlined in order to see the further details regarding the error.

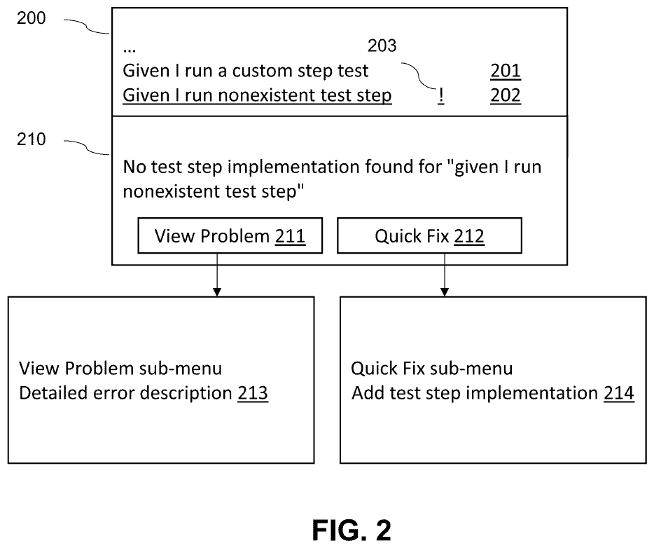

It should be appreciated that although the example above describes detecting a nonexistent test step, other types of errors may also be detected by the IDE and highlighted/displayed in a similar manner (such as more generic syntax errors as described in more detail with reference to FIG. 2 below).

FIG. 2 illustrates an example graphical user interface 200 for handling errors in an IDE, according to one or more example embodiments. FIG. 2 illustrates the scenario in which the user has chosen to interact with either line 102 or indicator 103 from FIG. 1 in order to see further details regarding the error which has occurred with respect to line 102. Line 101, line 102, and indicator 103 are similar to line 201, line 202, and indicator 203 respectively.

Suggestion interface 210 (which may appear as a suggestion window) may be shown to the user upon determining that the error has occurred, and if the user has interacted with either line 202 or indicator 203 (by clicking, hovering, etc.). Suggestion interface 210 may provide a brief summary of the error, as well as a suggestion as to how to fix the error.

Buttons for view problem 211 and quick fix 212 are also provided. If the user interacts with view problem button 211 (e.g., by clicking or hovering), sub-menu 213 may be displayed (for example, either as a new window or for example as a drop-down menu), and may provide a more detailed description of the error which occurred. If the user interacts with quick fix button 212, sub-menu 214 may be displayed (for example, either as a new window or for example as a drop-down menu), and may provide a suggested fix for the issue. In this case, since the error which has occurred is that a nonexistent test step is detected, the suggested fix would be to add a new test step implementation.

It should be appreciated that although the above illustrated embodiment is described with respect to a single error of a nonexistent test step, other types of errors, as well as multiple errors at the same time, may be handled by suggestion interface 210. Further, although sub-menu 214 in the above example only describes a single option being displayed for fixing the issue, multiple options for fixing the issue could be included. Further options for adding the test step implementation may be included (e.g., selecting from different templates). Although a button and a dropdown menu are used in this particular example, other methods for allowing user input for the user to select a suggestion may be used.

As an example of an implementation with multiple errors, if the test step was invalid and the syntax usage (e.g., incorrect spelling of “AND” as “NAD”, not allowed structure such as an “And” or “Or” statement without Given/When/Then phrase associated with it) was also invalid, then both the invalid test step and the invalid syntax may be shown to the user in the suggestion interface 210. The suggestion interface 210 may also include a suggestion to fix the syntax error. The quick fix button 212 and corresponding sub-menu 214 for adding a new step may also include an option for user input to correct the syntax error.

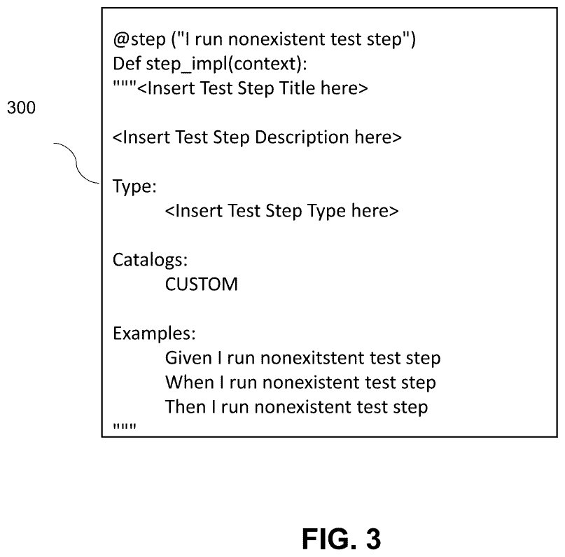

FIG. 3 illustrates an example generated template test step 300, according to one or more example embodiments. Generated template test step 300 may be provided based on interaction with the graphical user interface 100, 200 described above. In particular, the template test step 300 may be generated to have the same title “nonexistent test step” as originally entered in line 102, 202.

The user may be prompted to edit the new test step in a window. It should be appreciated that the template may include particular steps or syntax based on the original code which generated the error from FIGS. 1 and 2. The template may also vary based on the user input with respect to the suggestion interface 210 in FIG. 2. After the new test step is saved/added, the title of the new test step may appear in autocompletion suggestions when entering text/code into the code editor, and the suggestion interface 210/error highlighting illustrated in FIGS. 1-2 may no longer appear.

According to embodiments, the test step template may be in a docstring format. The new test step may include the title, (name which is the first sentence of the docstring and a one-line overview of the step as displayed in a test step list), a type (which describes the domain in which the test step may be used), a catalog (which specifies filters used to split generation), and examples of how to use the test steps within a feature file. In this example, CUSTOM is automatically imputed, and the examples already include the title from the user. It should be appreciated that the user input method in FIG. 2 may also include a user input such as a dropdown menu for selecting the catalog tag as some other option (for example, PUBLIC or INTERNAL). Accordingly, this template may be more streamlined and easier to share.

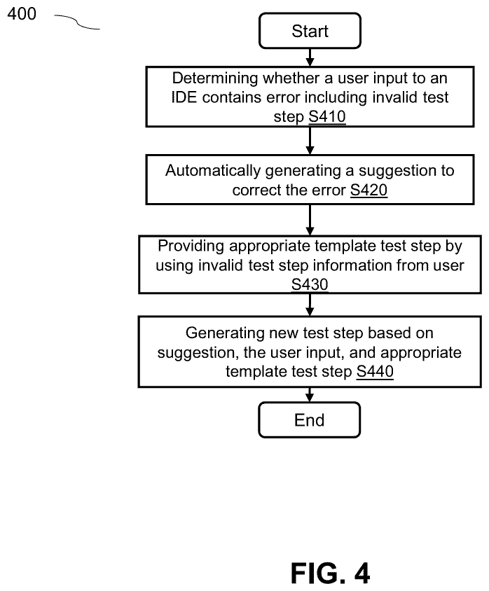

FIG. 4 illustrates an example method 400 for implementing generating a test step, according to one or more example embodiments.

At operation S410, it may be determined as to whether a user input to an IDE contains an error including an invalid test step.

At operation S420, based on determining the user input contains an error in operation S410, a suggestion for correcting the error may be automatically generated. The suggestion to correct the user may be previewed to the user in a user interface window (e.g., suggestion interface 210). The suggestion to correct the error may include at least one input method to allow the user to select an option for fixing the error and adding the new test step, such as a button and a dropdown menu (such as buttons 211, 212 and sub-menus 213, 214 described with reference to FIG. 2 above). According to embodiments, the error may further include at least one syntax error, and the suggestion further includes an explanation of the at least one syntax error and how to correct the at least one syntax error

At operation S430, an appropriate template test step may be provided, based on using the invalid test step information inputted by the user prior to operation S410.

At operation S440, a new test step may be generated based on the suggestion provided in operation S420, the user input provided prior to operation S410, and the appropriate template test step provided in operation S430. The user may be prompted to edit the new test step thereafter, and the generated new test step may already include the title of the test step from the user input.

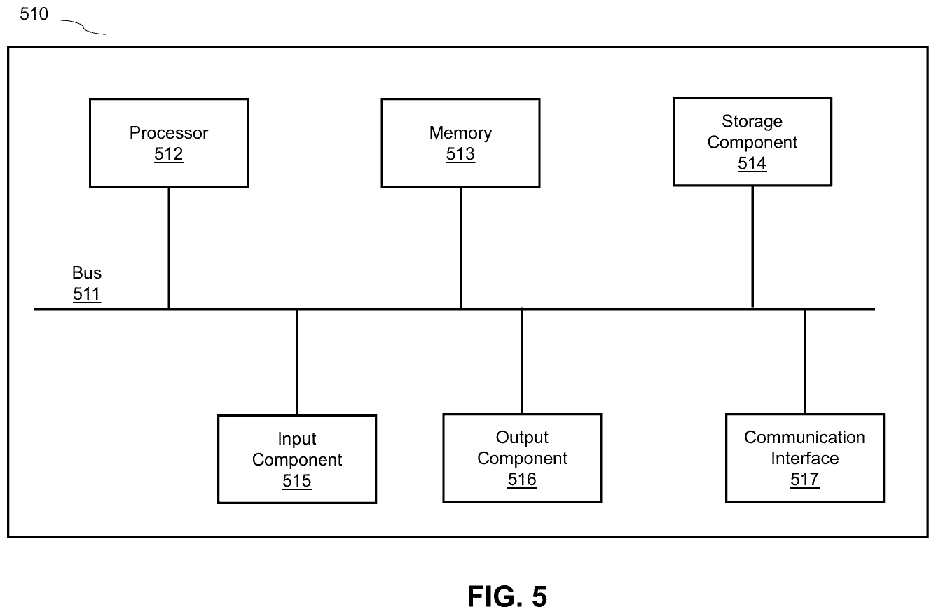

FIG. 5 illustrates a diagram of example components of a system, according to one or more example embodiments. As illustrated in FIG. 5, the system 510 may include at least one bus 511, at least one processor 512, at least one memory 513, at least one storage component 514, at least one input component 516, at least one output component 516, and at least one communication interface 517.

It is contemplated that the system 510 may include more or less components than illustrated in FIG. 5, without departing from the scope of the present disclosure. For instance, in some embodiments, the system 510 may include a plurality of storage components 514, the input component 515 and the output component 516 may be implemented as a transceiver component, the memory 513 and storage component 514 may be implemented as a memory storage, and the like.

The bus 511 may be configured to facilitate or enable communications among the components of the system 510. Specifically, the bus 511 may communicatively couple the components to each other and provide a means for data transfer and flow of control signals between the components. The bus 511 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 510 to enable communication and coordination between the components within the system 510 in real-time (or near real-time).

The processor 512 may be implemented in hardware, firmware, or a combination of hardware and software, and may be configured to handle real-time (or near real-time) data processing and control of the control system 510. The processor 512 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 510. In some implementations, the processor 512 may be capable of being programmed to perform one or more operations described herein. Further, the processor 512 may include a plurality of processing units, each of which is dedicated to performing a specific operation.

The memory 513 may include one or more mediums for storing temporary data, runtime variables, program instructions, and buffers required for the operations of the control system 510. The memory 513 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 510 to store information and/or instructions for use by the processor 512.

The storage component 514 may be configured to store non-volatile data, such as firmware, configuration settings, calibration data, information, and/or software related to the operation and use of the system 510. For example, the storage component 514 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 514 may be configured to store computer-readable or computer-executable instructions for implementing one or more operations of the system 510. The storage component 514 may provide the stored information to the memory 513 for the execution of the processor 512.

The input component 515 may include one or more input components that permit the system 510 to receive information, such as via user input (e.g., a touch screen display, a keyboard, a keypad, a mouse, a button, a switch, and/or a microphone). The output component 516 may include one or more output components that provide output information from the system 510 (e.g., a display, a speaker, a navigation device, one or more light-emitting diodes (LEDs), etc.) According to embodiments, the input component 515 and/or the output component 516 may be optional and may be excluded from the system 510.

The at least one communication interface 517 may include a transceiver-like component (e.g., a transceiver and/or a separate receiver and transmitter) that enables the system 510 to communicate with other components (e.g., ECUs, user devices, etc.), such as via a wired connection, a wireless connection, or a combination of wired and wireless connections. For example, communication interface 517 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 517 may include at least one input/output (I/O) interface, at least one network interface, at least one storage interface, or the like, that enable the components 512-516 to communicate with other components. Further, the communication interface 517 may include one or more application programming interfaces (APIs) that allow the system 510 (or one or more components included therein) to communicate with one or more software applications (e.g., software application deployed in the ECUs, etc.)

Computer-executable instructions (e.g., software instructions, etc.) may be read into memory 513 and/or storage component 514 from another computer-readable medium or from another device (e.g., a remote server, an external storage, etc.) via, for example, the communication interface 517. When executed, the computer-executable instructions stored in memory 513 and/or storage component 514 may cause the processor 512 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Based on the above, it can be understood that example embodiments of the present disclosure allow for integration of error handling with generating a new test step, such that the user/developer may be able to more seamlessly develop test steps and increase efficiency for testing in software development.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for generating a new test step, the method comprising:
determining whether a user input to an integrated development environment (IDE) contains an error including an invalid test step;
based on determining the user input contains an error, automatically generating a suggestion to correct the error;
providing an appropriate template test step by using the invalid test step information inputted by the user; and
generating a new test step based on the suggestion, the user input, and the appropriate template test step.

2. The method as claimed in claim 1, wherein the suggestion to correct the error is previewed to a user in a user interface window.

3. The method as claimed in claim 2, wherein the suggestion to correct the error includes at least one input method to allow the user to select an option for fixing the error and adding the new test step.

4. The method as claimed in claim 3, wherein the at least one input method includes a button and a dropdown menu.

5. The method as claimed in claim 1, further comprising:
based on generating the new test step, prompting the user to edit the new test step.

6. The method as claimed in claim 5, wherein a title of the generated new test step is based on the title of the test step from the user input.

7. The method as claimed in claim 1, wherein the error further includes at least one syntax error, and the suggestion further includes an explanation of the at least one syntax error and how to correct the at least one syntax error.

8. An apparatus for generating a new test step, the apparatus comprising:
at least one memory storing computer-executable instructions; and
at least one processor configured to execute the computer-executable instructions to:
determine whether a user input to an integrated development environment (IDE) contains an error including an invalid test step;
based on determining the user input contains an error, automatically generate a suggestion to correct the error;
provide an appropriate template test step by using the invalid test step information inputted by the user; and
generate a new test step based on the suggestion, the user input, and the appropriate template test step.

9. The apparatus as claimed in claim 8, wherein the suggestion to correct the error is previewed to a user in a user interface window.

10. The apparatus as claimed in claim 9, wherein the suggestion to correct the error includes at least one input method to allow the user to select an option for fixing the error and adding the new test step.

11. The apparatus as claimed in claim 10, wherein the at least one input method includes a button and a dropdown menu.

12. The apparatus as claimed in claim 8, wherein the at least one processor is further configured to execute the computer-executable instructions to:
based on generating the new test step, prompt the user to edit the new test step.

13. The apparatus as claimed in claim 12, wherein a title of the generated new test step is based on the title of the test step from the user input.

14. The apparatus as claimed in claim 8, wherein the error further includes at least one syntax error, and the suggestion further includes an explanation of the at least one syntax error and how to correct the at least one syntax error.

15. A non-transitory computer-readable recording medium having recorded thereon instructions executable by at least one processor to cause the processor to perform a method comprising:
determining whether a user input to an integrated development environment (IDE) contains an error including an invalid test step;
based on determining the user input contains an error, automatically generating a suggestion to correct the error;
providing an appropriate template test step by using the invalid test step information inputted by the user; and
generating a new test step based on the suggestion, the user input, and the appropriate template test step.

16. The non-transitory computer-readable recording medium as claimed in claim 15, wherein the suggestion to correct the error is previewed to a user in a user interface window.

17. The non-transitory computer-readable recording medium as claimed in claim 16, wherein the suggestion to correct the error includes at least one input method to allow the user to select an option for fixing the error and adding the new test step.

18. The non-transitory computer-readable recording medium as claimed in claim 17, wherein the at least one input method includes a button and a dropdown menu.

19. The non-transitory computer-readable recording medium as claimed in claim 15, the method further comprising:
based on generating the new test step, prompting the user to edit the new test step.

20. The non-transitory computer-readable recording medium as claimed in claim 19, wherein a title of the generated new test step is based on the title of the test step from the user input.
